(19) United States
(12) Patent Application Publication
(10) Pub. No.: US 2023/0153572 A1
(43) Pub. Date: May 18, 2023

(54) DOMAIN GENERALIZABLE CONTINUAL LEARNING USING COVARIANCES

(71) Applicant: NEC Laboratories America, Inc., Princeton, NJ (US)

(72) Inventors: Masoud Faraki, San Fransisco, CA (US); Yi-Hsuan Tsai, Santa Clara, CA (US); Xiang Yu, Mountain View, CA (US); Samuel Schulter, New York, NY (US); Yumin Suh, Santa Clara, CA (US); Christian Simon, Canberra (AU)

(21) Appl. No.: 17/971,204

(22) Filed: Oct. 21, 2022

Related U.S. Application Data
(60) Provisional application No. 63/278,512, filed on Nov. 12, 2021.

(51) Int. Cl. G06N 3/04; G06N 3/08

(52) U.S. Cl. CPC G06N 3/04; G06N 3/082

(57) ABSTRACT

A computer-implemented method for model training is provided. The method includes receiving, by a hardware processor, sets of images, each set corresponding to a respective task. The method further includes training, by the hardware processor, a task-based neural network classifier having a center and a covariance matrix for each of a plurality of classes in a last layer of the task-based neural network classifier and a plurality of convolutional layers preceding the last layer, by using a similarity between an image feature of a last convolutional layer from among the plurality of convolutional layers and the center and the covariance matrix for a given one of the plurality of classes, the similarity minimizing an impact of a data model forgetting problem.

### RELATED APPLICATION INFORMATION

This application claims priority to U.S. Provisional Patent Application No. 63/278,512, filed on Nov. 12, 2021, incorporated herein by reference in its entirety.

### BACKGROUND

### Technical Field

The present invention relates to artificial learning and more particularly to domain generalizable continual learning using covariances.

### Description of the Related Art

Deep learning has shown promising results on visual classification. A general visual classification task for real world scenarios is very complex due to dynamic nature of the data. The standard setup is to train and test on the same dataset with a fixed number of classes. However, in real world scenarios, the number of object classes keeps growing from time to time. Due to this problem, the models need to adapt to learn new classes. While learning new classes is important, the models cannot let the performance of classifying previous classes degrade. This is known to be the catastrophic forgetting issue in the continual learning context. In addition, the vast majority of visual data created in different environments or timeframes suffers from distributional/domain shifts. Many current models fail to perform well when they have to adapt to learn new classes and to face the test data that has distributional shifts. Another desired property of the learned model is the ability to generalize to unseen domains. Some previous proposals in continual learning that matches the output of two different models do not handle the problem of distributional shifts. There is a need for a model capable of overcoming the aforementioned problems.

### SUMMARY

According to aspects of the present invention, a computer-implemented method for model training is provided. The method includes receiving, by a hardware processor, sets of images, each set corresponding to a respective task. The method further includes training, by the hardware processor, a task-based neural network classifier having a center and a covariance matrix for each of a plurality of classes in a last layer of the task-based neural network classifier and a plurality of convolutional layers preceding the last layer, by using a similarity between an image feature of a last convolutional layer from among the plurality of convolutional layers and the center and the covariance matrix for a given one of the plurality of classes, the similarity minimizing an impact of a data model forgetting problem.

According to other aspects of the present invention, a computer program product for model training is provided. The computer program product includes a non-transitory computer readable storage medium having program instructions embodied therewith. The program instructions are executable by a computer to cause the computer to perform a method. The method includes receiving, by a hardware processor, sets of images, each set corresponding to a respective task, The method further includes training, by the hardware processor, a task-based neural network classifier having a center and a covariance matrix for each of a plurality of classes in a last layer of the task-based neural network classifier and a plurality of convolutional layers preceding the last layer, by using a similarity between an image feature of a last convolutional layer from among the plurality of convolutional layers and the center and the covariance matrix for a given one of the plurality of classes, the similarity minimizing an impact of a data model forgetting problem.

According to still other aspects of the present invention, a computer processing system for model training is provided. The computer processing system includes a memory device for storing program code. The computer processing system further includes a hardware processor operatively coupled to the memory device for running the program code to receive sets of images, each set corresponding to a respective task. The hardware processor further runs the program code to train a task-based neural network classifier having a center and a covariance matrix for each of a plurality of classes in a last layer of the task-based neural network classifier and a plurality of convolutional layers preceding the last layer, by using a similarity between an image feature of a last convolutional layer from among the plurality of convolutional layers and the center and the covariance matrix for a given one of the plurality of classes, the similarity minimizing an impact of a data model forgetting problem.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block diagram showing an exemplary computing device, in accordance with an embodiment of the present invention;

FIG. 2 is a block diagram showing an exemplary system flow, in accordance with an embodiment of the present invention;

FIG. 3 is a block diagram showing an exemplary system configuration, in accordance with an embodiment of the present invention;

FIG. 4 is a block diagram showing an exemplary system, in accordance with an embodiment of the present invention;

FIG. 5 shows an exemplary method for domain generalizable continual learning using covariances, in accordance with an embodiment of the present invention; and

FIG. 6 is a diagram showing exemplary pseudocode 600 for training, in accordance with an embodiment of the present invention.

### DETAILED DESCRIPTION OF PREFERRED EMBODIMENTS

Embodiments of the present invention are directed to domain generalizable continual learning using covariances.

Embodiments of the present invention we consider the realistic scenario of continual learning under domain shifts where the model is able to generalize its inference to an unseen domain. To this end, embodiments of the present invention make use of sample correlations of the learning tasks in the classifiers where the subsequent optimization is performed over similarity measures obtained in a similar fashion to the Mahalanobis distance computation. In addition, we also propose an approach based on the exponential moving average of the parameters for better knowledge distillation, allowing a further adaptation to the old model.

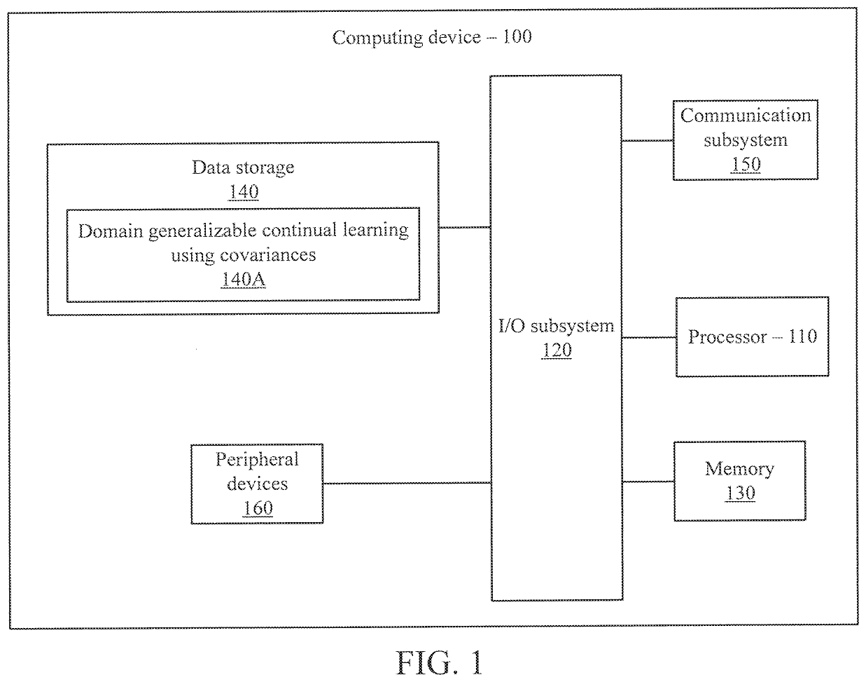

FIG. 1 is a block diagram showing an exemplary computing device 100, in accordance with an embodiment of the present invention. The computing device 100 is configured to perform domain generalizable continual learning using covariances.

The computing device 100 may be embodied as any type of computation or computer device capable of performing the functions described herein, including, without limitation, a computer, a server, a rack based server, a blade server, a workstation, a desktop computer, a laptop computer, a notebook computer, a tablet computer, a mobile computing device, a wearable computing device, a network appliance, a web appliance, a distributed computing system, a processor-based system, and/or a consumer electronic device. Additionally or alternatively, the computing device 100 may be embodied as a one or more compute sleds, memory sleds, or other racks, sleds, computing chassis, or other components of a physically disaggregated computing device. As shown in FIG. 1, the computing device 100 illustratively includes the processor 110, an input/output subsystem 120, a memory 130, a data storage device 140, and a communication subsystem 150, and/or other components and devices commonly found in a server or similar computing device. Of course, the computing device 100 may include other or additional components, such as those commonly found in a server computer (e.g., various input/output devices), in other embodiments. Additionally, in some embodiments, one or more of the illustrative components may be incorporated in, or otherwise form a portion of, another component. For example, the memory 130, or portions thereof, may be incorporated in the processor 110 in some embodiments.

The processor 110 may be embodied as any type of processor capable of performing the functions described herein. The processor 110 may be embodied as a single processor, multiple processors, a Central Processing Unit(s) (CPU(s)), a Graphics Processing Unit(s) (GPU(s)), a single or multi-core processor(s), a digital signal processor(s), a microcontroller(s), or other processor(s) or processing/controlling circuit(s).

The memory 130 may be embodied as any type of volatile or non-volatile memory or data storage capable of performing the functions described herein. In operation, the memory 130 may store various data and software used during operation of the computing device 100, such as operating systems, applications, programs, libraries, and drivers. The memory 130 is communicatively coupled to the processor 110 via the I/O subsystem 120, which may be embodied as circuitry and/or components to facilitate input/output operations with the processor 110 the memory 130, and other components of the computing device 100. For example, the I/O subsystem 120 may be embodied as, or otherwise include, memory controller hubs, input/output control hubs, platform controller hubs, integrated control circuitry, firmware devices, communication links (e.g., point-to-point links, bus links, wires, cables, light guides, printed circuit board traces, etc.) and/or other components and subsystems to facilitate the input/output operations. In some embodiments, the I/O subsystem 120 may form a portion of a system-on-a-chip (SOC) and be incorporated, along with the processor 110, the memory 130, and other components of the computing device 100, on a single integrated circuit chip.

The data storage device 140 may be embodied as any type of device or devices configured for short-term or long-term storage of data such as, for example, memory devices and circuits, memory cards, hard disk drives, solid state drives, or other data storage devices. The data storage device 140 can store program code for domain generalizable continual learning using covariances. The communication subsystem 150 of the computing device 100 may be embodied as any network interface controller or other communication circuit, device, or collection thereof, capable of enabling communications between the computing device 100 and other remote devices over a network. The communication subsystem 150 may be configured to use any one or more communication technology (e.g., wired or wireless communications) and associated protocols (e.g., Ethernet, InfiniBand®, Bluetooth®, Wi-Fi®, WiMAX, etc.) to effect such communication.

As shown, the computing device 100 may also include one or more peripheral devices 160. The peripheral devices 160 may include any number of additional input/output devices, interface devices, and/or other peripheral devices. For example, in some embodiments, the peripheral devices 160 may include a display, touch screen, graphics circuitry, keyboard, mouse, speaker system, microphone, network interface, and/or other input/output devices, interface devices, and/or peripheral devices.

Of course, the computing device 100 may also include other elements (not shown), as readily contemplated by one of skill in the art, as well as omit certain elements. For example, various other input devices and/or output devices can be included in computing device 100, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized. These and other variations of the processing system 100 are readily contemplated by one of ordinary skill in the art given the teachings of the present invention provided herein.

As employed herein, the term “hardware processor subsystem” or “hardware processor” can refer to a processor, memory (including RAM, cache(s), and so forth), software (including memory management software) or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), FPGAs, and/or PLAs.

These and other variations of a hardware processor subsystem are also contemplated in accordance with embodiments of the present invention

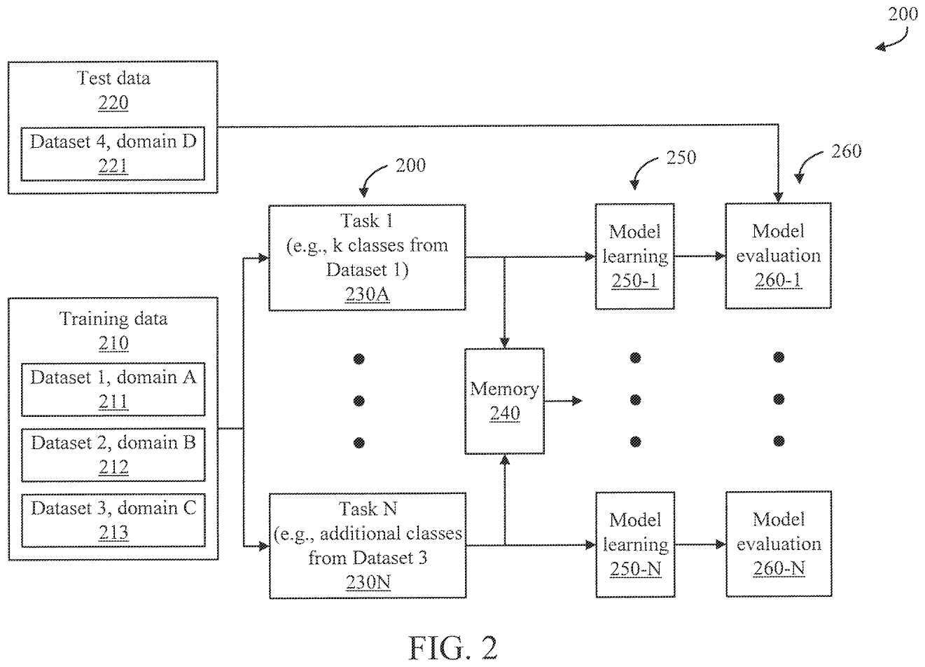

In our setup for the aforementioned problems, i.e., the catastrophic forgetting and distribution shift problems, the training data is given in a sequential manner in the form of a task as shown in FIG. 2. FIG. 2 is a block diagram showing an exemplary system flow 200, in accordance with an embodiment of the present invention. In training data 210, a novel task is defined with distinct classes and domains. The test data includes a disjoint set coming from an unseen domain with the set of classes covered up to the current time point. The training data includes multiple datasets 211 through 213, each corresponding to a different domain (e.g., domains A through C). The overall setting in cross-domain continual learning which has a sequence of visual categories coming from various domains shown in 230A to 230N. More specifically, the training problem is divided into several tasks, where each new task has a subset of novel object categories coming from various training domains. While the training data from old tasks is discarded at each time, the model has to learn sequentially from the incoming tasks to evaluate on inputs from an unseen domain with a different distribution, 220 and 221. In the training process, the model has limited access to data from previous tasks, i.e., the samples from previous tasks can be stored in a limited memory, 240. In the learning algorithm, there are distinct parameters for each task, 250-1 to 250-N, with separate evaluations 260-1 to 260 N. There are two problems in this challenging setup: (1) the performance of previous task degrades which is known as catastrophic forgetting and (2) the distributional shifts occur when learning a novel task and generalization on test data for an unseen domain. Here, in an embodiment, the present invention attempts to solve the problem of training the model in a continual learning paradigm with incremental classes and domain shifts. Embodiments of the present invention aim to alleviate the catastrophic forgetting problem and reduce distributional shifts between tasks.

A description will now be given regarding a practical example, in accordance with an embodiment of the present invention.

Our model is trained in a sequential manner with diverse classes and domains per task. The present invention can handle incremental classes and domains given in a sequence. The test data is in a new domain which is excluded from the training data. For instance, a robot learns to classify objects from unseen classes under different lighting conditions.

In an embodiment, the present invention focuses on alleviating the domain shifts and learning new classes from a novel task. The learning mechanism is designed to accommodate the new additional parameters and the current parameters when learning a novel task. We exploit the consistency between two consecutive tasks using covariances such that they can capture the underlying curvature for a similarity metric.

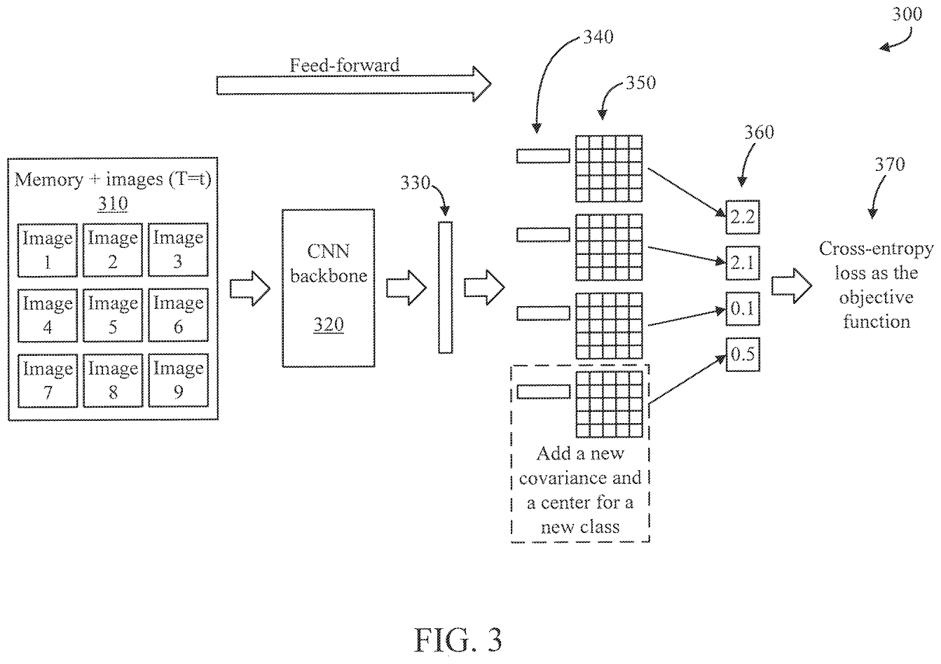

FIG. 3 is a block diagram showing an exemplary system configuration 300, in accordance with an embodiment of the present invention.

The goal is to learn a model that can learn from various domains and classes and have a generalization capability to classify from an unseen domain. The novel classifier includes flattening a multidimensional feature into a set of features in 2D 330, a center (offset) 340, and a covariance matrix 350 for each class as a replacement of a standard fully-connected layer. The objective function uses the similarity between the feature (the output of the last convolutional layer of the CNN backbone 320) and the center 340 and the covariance 350. The distance to measure similarity is calculated as in the Mahalanobis Distance to induce a Riemmanian geometry. The distance calculation 360 for every class is the squared distance of the difference between the sample representation and the class-center multiplied by the decomposed class-covariance and the output is considered as a prediction. The training objective is to minimize the cross-entropy loss 370 between the prediction and the label. In embodiments of the present invention, we update a center and a covariance for each class from both the samples in memory 310 and the current task. The covariance matrix describes the shape of the samples from previous tasks to reduce the catastrophic forgetting problem while it also imposes class-wise domain alignment among tasks with different domains in the form of transformation.

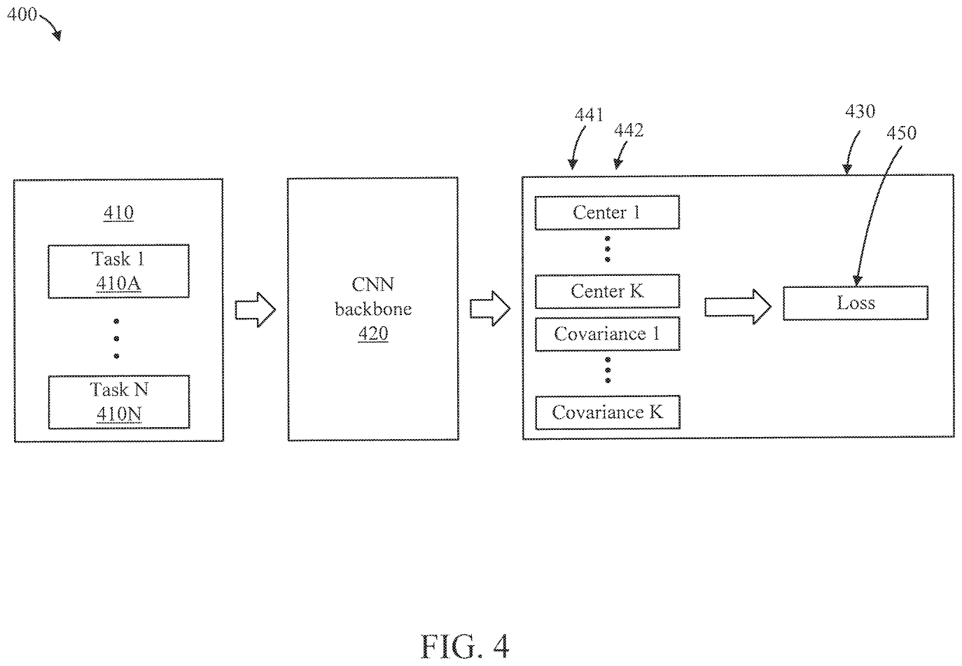

FIG. 4 is a block diagram showing an exemplary system 400, in accordance with an embodiment of the present invention.

Boxes denoted by the figure reference numeral 410 indicate data in the form of sequential tasks (from task 410A through task 410N) and arrows indicate data flow. Boxes denoted by the figure reference numeral 420 indicate the parameters to be updated during training in a CNN backbone. Box 430 indicates a loss function. Box 450 indicates the loss.

Training Datasets

The input images come from N datasets denoted as Dataset1, Dataset2, . . . Dataset N. Each dataset comes from a different domain and corresponds to a different task 410 (from among tasks 410A through 410N). One dataset is picked for the test data. The N−1 datasets are used for training and given sequentially as the chunk of data. The classes are sequentially added from a dataset with a corresponding domain that is randomly picked. To replay previous tasks, we reserve some images in the memory.

Backbone Convolutional Neural Network (CNN)

We perform a forward pass using the samples of the current task and the memory, and produce a representation of an image using a CNN backbone 420. The model is updated using the data in the current task and in the memory.

Covariances and Centers Construction, Predicting, and Learning Strategies (main invention)

Covariances and Centers Construction (Main Invention)

The fully-connected layer is replaced with a novel layer including centers 442 and covariances 441. The covariances 441 and centers 442 are initialized with random initialization. The covariance 441 can be even squeezed using decomposition. In the novel layer, every class has its corresponding covariance matrix and center. When a new class comes, a randomly initialized covariance 441 and center 442 are added.

Covariances and Centers for Predictions (Main Invention)

The output representation of the backbone CNN interacts with the centers and the covariances. The notion of similarity between a sample and a class is calculated using the squared distance. In particular, the squared distance is a difference between a class-center and a representation multiplied by a decomposed covariance. The prediction is constructed based on the similarity scores calculated using the squared distance.

Covariances and Centers Learning Strategies (Main Invention)

Input images come from the current task data and the memory. The images in memory are replayed and feed-forwarded through a CNN backbone and the novel layer. The output after the novel (last) layer is a prediction that is used to calculate loss with a corresponding label. For a novel task with new classes, the newly added centers and covariances are updated while the centers and the covariances from previous tasks keep unchanged.

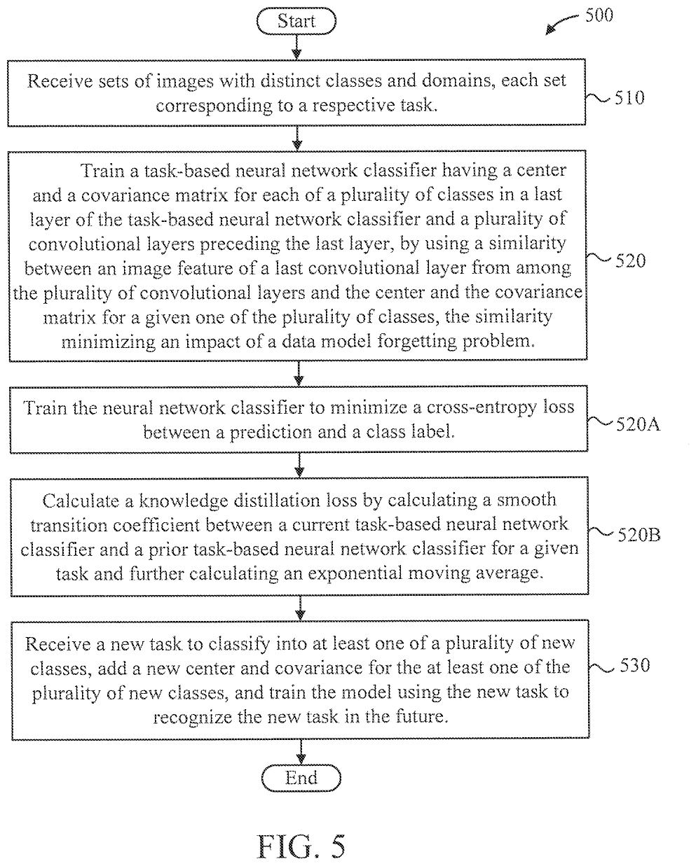

FIG. 5 shows an exemplary method 500 for domain generalizable continual learning using covariances, in accordance with an embodiment of the present invention.

At block 510, receive sets of images with distinct classes and domains, each set corresponding to a respective task.

At block 520, train a task-based neural network classifier having a center and a covariance matrix for each of a plurality of classes in a last layer of the task-based neural network classifier and a plurality of convolutional layers preceding the last layer, by using a similarity between an image feature of a last convolutional layer from among the plurality of convolutional layers and the center and the covariance matrix for a given one of the plurality of classes. The similarity minimizes an impact of a data model forgetting problem.

In an embodiment, block 520 can include one or more of blocks 520A and 520B.

At block 520A, train the neural network classifier to minimize a cross-entropy loss between a prediction and a class label.

At block 520B, calculate a knowledge distillation loss by calculating a smooth transition coefficient between a current task-based neural network classifier and a prior task-based neural network classifier for a given task and further calculating an exponential moving average.

At block 530, receive a new task to classify into at least one of a plurality of new classes, add a new center and covariance for the at least one of the plurality of new classes, and train the model using the new task to recognize the new task in the future.

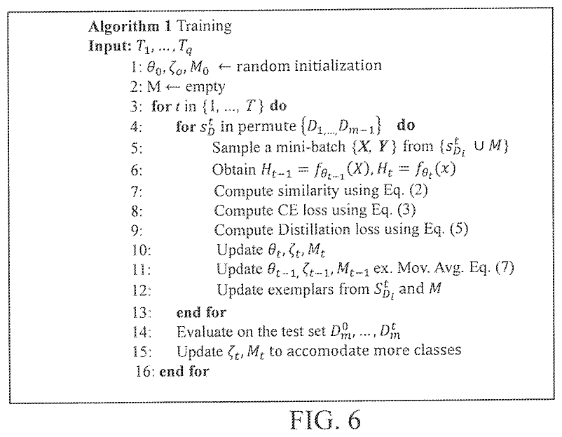

FIG. 6 is a diagram showing exemplary pseudocode 600 for training, in accordance with an embodiment of the present invention.

We now present our approach to learning tasks sequentially with: (1) the constraints on the storage of the previously observed learning samples, and (2) severe distribution shifts within the learning tasks, without suffering from the so-called issue of catastrophic forgetting. Our learning scheme identifies the feature and metric learning jointly. Specifically, we learn class-specific distance metrics defined in the latent space to increase the discriminatory power of features in the space. This is done seamlessly along with learning the features themselves.

Below, we first review some basic concepts used in our framework. Then, we provide our main contribution to learn domain generalizable features. Finally, we incorporate the solution into a moving average scheme to enhance the recognition performances.

Herein, we denote vectors and matrices in bold lower-case letters (, x) and bold upper-case letters (X), respectively. [x]ᵢ denotes the element at position i in x. We denote a set by S.

Formally, in continual learning, a model is trained in several steps called tasks. Each task Tᵢ, 1≤i≤q, consists of samples of a set of novel classes Yᵢ^{N} as well as samples of a set of old classes Yᵢ^{O}. The aim is to train a model to classify all seen classes, yᵢ^{O} ∪Yᵢ^{N}. The allowed number of training samples for Yᵢ^{O} is severely constrained (called rehearsal memory M).

In our cross-domain continual learning setup, we tackle the recognition scenario where during training we observe m source domains, D1, . . . , Dm, each with different distributions. The learning sequence is defined as learning through a stream of tasks T₁, . . . , T_{q}, where the data from each task is composed of a sequence of m source domains. We do not impose any assumption on the order of the incoming domain samples. In fact, we are interested in averaging the performance measures when domains are chosen randomly and the process is repeated for a number of times (, 5). Like the standard continual learning set-up, knowledge from a new set of classes is learned from each novel task. At the test time, we follow the domain generalization evaluation pipeline in which the trained model has to predict y∈Yᵢ, 1≤i≤q values of inputs from an unseen/target domain Dₘ₊₁. We note that Dₘ₊₁ has samples from an unknown distribution.

Like a standard continual learning method, we also apply experience replay by storing exemplars in the memory. This would help preventing the forgetting issue. The exemplars stored in the memory are constructed from each class and each domain. We pick randomly the exemplars to be stored in the memory and ensure every run containing same set.

Domain Generalization by Learning Similarity Metrics

We start by introducing the overall network architecture. Our architecture closely follows a typical image recognition design used in continual learning methods. Let f_{θ}: X→H represents a backbone CNN parametrized by θ which provides a mapping from the image input space to a latent space. Furthermore, let f_{w}: H→Y be a classifier network that maps the outputs of f_{θ} to class label values. More specifically, forwarding an image I through f_{θ}(·) outputs a tensor fₒ(I)∈ [symbol] ^{H×W×D} that, after being flattened (, [symbol] ^{H×W×D}→Rⁿ), acts as input to the classifier network f_{w}(·). In a typical pipeline, the goal is to train a model on each task Tᵢ, 1≤i≤q, while expanding the output size of the classifier to match the number of classes. Note that the sequential learning protocol in our setting does not have strong priors and assumptions, domain identities and overlapping classes.

In most continual learning methods, the classifier network f_{w} is often implemented by a Fully-Connected (FC) layer with weight W=[w₁, . . . , w_{|C|}] where w Rn. When learning a new task, W is expanded to cover k the new task categories by adding k new rows, W=[w₁, . . . , w_{|c|}, w_{|c|+1, . . . ,}w_{|c|+k}]^{T}. A similarity score between a class weight we and a feature h is then defined by projection as to be optimized by a loss function. Despite its wide use, we argue that this approach is not robust to distributional shifts as it is not explicitly designed to recognize samples from the previously seen classes from a different distribution.

Here, we deem the domain alignment be done in a dis-criminative manner. In doing so, we are aligned with adjacent applications, the Contrastive Adaptation Network (CAN) for unsupervised domain adaptation, the Covariance Metric Networks (CovaMNet) for few-shot learning, the Model-Agnostic learning of Semantic Features (MASF) for standard domain generalization and the Cross-Domain Triplet (CDT) loss for face recognition from unseen domains to name a few. They acknowledge class samples to avoid undesirable effects, such as aligning semantically different samples from different domains.

To this end, we equip the latent space with PSD Mahalanobis similarity metrics, to encourage learning semantically meaningful features. We then learn the backbone representation parameters along with the metrics in an end-to-end scheme. We allow category features to shift by also learning a bias vector b. Therefore, the prediction layer in our framework consists of learnable parameters ζ=[Σ1, b1, . . . , Σ|C|, b|C|]. Here, the classifier network also takes into account the underlying distribution of the class samples when generating the predictions.

To better understand the behavior of our learning algorithm, let c be a set of examples from different domains with class label c. Then, the similarity score can be obtained by the following:

$${[ s ]}_{c} = \frac{1}{\vert {X}_{c} \vert - 1} {\sum }_{{x}_{i} ∈ {X}_{c}} {r}_{c}^{T} \sum {r}_{c}^{T} {\sum }_{c} {r}_{c} \qquad ( 1 )$$

where r_{c}=(f_{θ}(xᵢ) b_{c}).

The eigendecomposition inside the summation reveals the following:

$${r}_{c}^{T} {\sum }_{c} {r}_{c} = {( {∧}_{c}^{\frac{1}{2}} {V}_{c}^{T} {r}_{c} )}^{T} = {\vert \vert {∧}_{c}^{\frac{1}{2}} {V}_{c}^{T} {r}_{c} \vert \vert}_{2}^{2}$$

which associates r_{c} with the eigenvectors of Σ_{c} weighted by the eigenvalues. When r_{c} is in the direction of leading eigenvectors of Σ_{c}, it obtains its maximum value. Then, optimizing this term over X_{c} samples leads to a more discriminative alignment of the data sources.

As mentioned that we have a memory of exemplars from various domains as well, thus the learnable parameters can be updated towards a more generalized classifier as an attempt to improve classification on unseen domains. The PSD matrix can be decomposed to Σ_{c}=L_{C}^{T}L_{c}, where L∈ [symbol] ^{u×n} and u<<n. This can substantially reduce storage needs and increase the scalability of our method when a large-scale application is deemed. Using the decomposition, the summation in Equation (1) boils down to the following:

d²(x,L_{c},b_{c})=∥L_{c}(f_{θ}(x)−b_{c})∥₂² (2)

As a result, we store less parameters with this decomposition compared to a full-rank PSD matrix. Furthermore, this lets us conveniently implement Σ by a FC layer into any neural network.

For a task t, we train our model using the cross-entropy loss, which is widely used for Empirical Risk Minimization (ERM):

$$L ( x , θ , ζ ) = - {\sum }_{x ∈ {s}_{t} ⋃ M} {δ}_{y = c} log \frac{exp ( - {d}^{2} ( x , {L}_{c} , {μ}_{c} ) )}{{\sum }_{{c}^{′}} exp ( - {d}^{2} ( x , {L}_{{c}^{′}} , {μ}_{{c}^{′}} ) )} \qquad ( 3 )$$

where δ is an indicator function corresponding with the label y.

In our continual learning setup, we store some examples through tasks and various domains. During training, the samples in mini-batches X=[x₁, . . . , x_{b}] come from samples in the current task t and the memory with multiple domains D₁, . . . , Dₘ₋₁ and previously learned classes 1, . . . , (|CTt−1|). Thus, our objective becomes minimizing the loss function across domains and samples (x, θ, ζᵢ). The metric matrix that represents each class can be updated during training:

ζⁱ⁺¹=ζⁱ−η∇_{ζ}ⁱL(x,θ,ζⁱ) (4)

The update direction for each W_{c} is not dominated by a specific domain because of past samples from multiple domains in the memory are replayed during training.

Knowledge Distillation with Exponential Momentum Average

A common strategy to prevent catastrophic forgetting is to apply knowledge distillation using old and current models. Let Ψₜ=θₜ, ζₜ, Mₜ be all learnable parameters in our framework at task t, and \tilde{p}(x) and p(x) denote the output predictions from the old model Ψₜ₋₁ and the current model Ψₜ. Then, knowledge distillation on the predictions with a temperature τ is formulated as follows:

$${L}_{Dis} ( {Ψ}_{t} ; {Ψ}_{t - 1} ; x ) = - {\sum }_{c = 1}^{\vert C \vert} {\tilde{ϕ}}_{c} ( x ) log {ϕ}_{c} ( x ) , \qquad ( 5 )$$

$$where$$

$${\tilde{ϕ}}_{c} ( x ) = \frac{exp ( {\tilde{p}}_{c} ( \frac{x}{τ} )}{{{\sum }_{{c}^{′} = 1}}^{\vert C \vert} exp ( \frac{{\tilde{p}}_{{c}^{′}} ( x )}{τ} )} , {ϕ}_{c} ( x ) = \frac{exp ( \frac{{p}_{c} ( x )}{τ} )}{{{\sum }_{{c}^{′} = 1}}^{\vert C \vert} exp ( \frac{{p}_{{c}^{′}} ( x )}{τ} )} \qquad ( 6 )$$

The assumption is that the outputs of the current model must match with the old ones. We argue that the changes in neural network parameters when sequentially learning new tasks are inevitable when learning multiple domains sequentially. Thus, we employ a slightly changing parameter update to model slow adaptation to the old model. The changes applied to the old model can be interpreted as a smooth transition for knowledge distillation between out-puts of old and current models. We define the exponential moving average in our framework as follows:

θ′=γθ′+(1−γ)θ

μ′_{c}=γμ′_{c}+(1−γ)μ_{c}

Σ′_{c}=γΣ′_{c}+(1−γ)Σ_{c}, (7)

where γ is a smoothing coefficient parameter. We use the factorized parameters L_{c} for reconstructing the metric matrix Σ_{c}=L_{c}L_{c}^{T} before applying the exponential moving average using Equation (7) and decompose it again into L′_{c}.

Remark 1: We consider the exponential moving average technique as the swelling effect in our framework. The old model is exposed to sequential multiple domains during training. In consequence, the old model has not learned new visual categories with a new domain. To avoid knowledge distillation inclined for a specific domain, the old parameters require some adaptation to soften the knowledge distillation constraint.

Connection to Batch Normalization

A simplistic strategy to build Σ_{c} is by estimating the standard deviation of the sample points to the mean value μ. This approach in the deep learning literature is known as BatchNorm (batch normalization). Below, we draw a connection between our approach and BatchNorm. As widely known, BatchNorm can reduce covariate shifts, stabilize learning, and reduce generalization errors. In the BatchNorm formulation, the statistics (mean and variance) of the output hi of a layer in a neural network with a batch size b are computed as:

$$\begin{matrix}{μ}_{B} = \frac{1}{b} {{\sum }_{i = 1}}^{b} {h}_{i} , & {σ}_{B}^{2} = \frac{1}{b} {{\sum }_{i = 1}}^{b} {( {h}_{i} - {μ}_{b} )}^{2}\end{matrix} \qquad ( 8 )$$

The output of a neural network layer is normalized using batch-wise statistics and hyper-parameters to scale the transformation α and β:

$${\tilde{h}}_{i} = α \frac{( {h}_{i} - μ )}{\sqrt{{σ}^{2} + ε}} + β \qquad ( 9 )$$

We can interpret the divisor as Σ=Diag (σ²+ϵ)^{-1/2}, where c is a constant to avoid numerical errors.

The drawback of the BatchNorm approach is that it assumes samples are distributed around the mean with a spherical shape, yielding a metric matrix with zero off-diagonal elements. To resolve this issue, we propose a metric matrix with non-zero off-diagonal elements Σ_{c} and even further reduce the computational requirements using matrix decomposition Σ_{c}=L_{c}L_{c}^{T}. This decomposition reduces the computational complexity from ϑ(n²) to ϑ(un), where u<<n. Compared to BatchNorm, our proposed metric matrix enjoys more expressive modelled distribution, while our approach maintains low time and space complexity.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A computer-implemented method for model training, comprising
receiving, by a hardware processor, sets of images, each set corresponding to a respective task; and
training, by the hardware processor, a task-based neural network classifier having a center and a covariance matrix for each of a plurality of classes in a last layer of the task-based neural network classifier and a plurality of convolutional layers preceding the last layer, by using a similarity between an image feature of a last convolutional layer from among the plurality of convolutional layers and the center and the covariance matrix for a given one of the plurality of classes, the similarity minimizing an impact of a data model forgetting problem.

2. The computer-implemented method of claim 1, wherein the similarity is measured based on a distance calculation made using a Mahalanobis distance that induces a Riemmanian geometry.

3. The computer-implemented method of claim 2, wherein the distance calculation for a given one of the plurality of classes is a squared distance of a difference between a sample representation of the image feature and a class-center of the given one of the plurality of classes multiplied by a decomposed covariance.

4. The computer-implemented method of claim 3, wherein the distance calculation is a prediction.

5. The computer-implemented method of claim 1, further comprising training the neural network classifier to minimize a cross-entropy loss between a prediction and a class label.

6. The computer-implemented method of claim 1, further comprising:
receiving a new task to classify into at least one of a plurality of new classes;
adding a new center and covariance for the at least one of the plurality of new classes; and
training the model using the new task to recognize the new task in the future.

7. The computer-implemented method of claim 1, wherein the neural network is trained using training data comprising respective pluralities of images pertaining to respective given tasks with distinct classes and domains.

8. The computer-implemented method of claim 1, further comprising calculating a knowledge distillation loss by calculating a smooth transition coefficient between a current task-based neural network classifier and a prior task-based neural network classifier for a given task and further calculating an exponential moving average.

9. The computer-implemented method of claim 1, wherein the task-based neural network classifier uses covariance to estimate a curvature between a mean in the task-based neural network classifier and an image feature from a new task.

10. A computer program product for model training, the computer program product comprising a non-transitory computer readable storage medium having program instructions embodied therewith, the program instructions executable by a computer to cause the computer to perform a method comprising:
receiving, by a hardware processor, sets of images, each set corresponding to a respective task; and
training, by the hardware processor, a task-based neural network classifier having a center and a covariance matrix for each of a plurality of classes in a last layer of the task-based neural network classifier and a plurality of convolutional layers preceding the last layer, by using a similarity between an image feature of a last convolutional layer from among the plurality of convolutional layers and the center and the covariance matrix for a given one of the plurality of classes, the similarity minimizing an impact of a data model forgetting problem.

11. The computer program product of claim 10, wherein the similarity is measured based on a distance calculation made using a Mahalanobis distance that induces a Riemmanian geometry.

12. The computer program product of claim 11, wherein the distance calculation for a given one of the plurality of classes is a squared distance of a difference between a sample representation of the image feature and a class-center of the given one of the plurality of classes multiplied by a decomposed covariance.

13. The computer program product of claim 12, wherein the distance calculation is a prediction.

14. The computer program product of claim 10, further comprising training the neural network classifier to minimize a cross-entropy loss between a prediction and a class label.

15. The computer program product of claim 10, further comprising:
receiving a new task to classify into at least one of a plurality of new classes;
adding a new center and covariance for the at least one of the plurality of new classes; and
training the model using the new task to recognize the new task in the future.

16. The computer program product of claim 10, wherein the neural network is trained using training data comprising respective pluralities of images pertaining to respective given tasks with distinct classes and domains.

17. The computer program product of claim 10, further comprising calculating a knowledge distillation loss by calculating a smooth transition coefficient between a current task-based neural network classifier and a prior task-based neural network classifier for a given task and further calculating an exponential moving average.

18. The computer program product of claim 10, wherein the task-based neural network classifier uses covariance to estimate a curvature between a mean in the task-based neural network classifier and an image feature from a new task.

19. A computer processing system for model training, comprising:
a memory device for storing program code; and
a hardware processor operatively coupled to the memory device for running the program code to:
receive sets of images, each set corresponding to a respective task; and
train a task-based neural network classifier having a center and a covariance matrix for each of a plurality of classes in a last layer of the task-based neural network classifier and a plurality of convolutional layers preceding the last layer, by using a similarity between an image feature of a last convolutional layer from among the plurality of convolutional layers and the center and the covariance matrix for a given one of the plurality of classes, the similarity minimizing an impact of a data model forgetting problem.

20. The computer processing system of claim 19, wherein the similarity is measured based on a distance calculation made using a Mahalanobis distance that induces a Riemmanian geometry.
